(19) United States
(12) Patent Application Publication
(10) Pub. No.: US 2020/0130933 A1
(43) Pub. Date: Apr. 30, 2020

(54) LOADING GANTRY

(71) Applicant: Liebherr-Verzahntechnik GmbH, Kempten (DE)

(72) Inventors: Thomas MATTERN, Rieden (DE); Vanessa ALBRECHT, Altusried (DE); Konrad BECHTELER, Betzigau (DE)

(21) Appl. No.: 16/667,717

(22) Filed: Oct. 29, 2019

(30) Foreign Application Priority Data
Oct. 30, 2018 (DE) 10 2018 127 102.6

(51) Int. Cl. B65G 1/04; B65G 1/137

(52) U.S. Cl. CPC B65G 1/0464; B65G 1/1375

(57) ABSTRACT

The present application comprises a loading gantry with at least one carriage traversable on a horizontal guide rail, in particular for the transport of workpieces between stations of a production system. In accordance with the application the loading gantry includes a media station which in at least one position of the carriage releasably can be mechanically coupled with the same in order to produce at least one media connection between the media station and the carriage.

### CROSS-REFERENCE TO RELATED APPLICATION

The present application claims priority to German Application No. DE 10 2018 127 102.6 entitled “LOADING GANTRY”, filed on Oct. 30, 2018. The entire contents of the above listed application are hereby incorporated by reference for all purposes.

### TECHNICAL FIELD

The present application relates to a loading gantry with at least one carriage traversable on a horizontal guide rail. Such loading gantries in particular serve the transport of workpieces between stations of a machining system such as machining centers and/or feeding and/or discharging devices. Such loading gantries in part are also referred to as gantry robot or overhead transfer device.

### BACKGROUND AND SUMMARY

In the series production of workpieces, in particular the mechanical machining of workpieces, the workpieces generally are sequentially fed to a plurality of machine tools according to an exactly planned production sequence. For this purpose, the workpieces initially are introduced into the production system via a feeding device and then transported from one machining center to the next within the production system. Depending on the number of manufacturing operations, the workpieces either are discharged from the production system via a discharging device or are handed over to another production system via an intermediate automation. The transport of the workpieces from one station of the production system to the next can be effected via a loading gantry. In the production system, a plurality of loading gantries can also operate in parallel or in series. Furthermore, a plurality of carriages can be provided at the loading gantry.

Loading gantries usually are fully automated, wherein the actuation of the carriages is effected via stationary, centrally arranged control units which coordinate the operation of the carriages with the operation of the machining centers and the feeding and/or discharging devices.

Such loading gantries are known for example from DE 10 2012 011 534 A1, DE 10 2013 014 266 A1 and DE 10 2014 014 874 A1. Other loading gantries include a supply chain with corresponding supply lines for supplying the carriage or carriages with energy and lubricant and for the data transmission with the carriage. Due to the movement of the carriage, however, supply chains are exposed to a considerable wear. Furthermore, a subsequent extension of the loading gantry only is possible by completely exchanging the supply chain. There also exists a safety risk, as the supply chain can fall down from its bearing surface.

In DE 10 2006 049 588 A1 a transport system with a rail system and carriages movable thereon is disclosed, wherein the rails comprise a primary conductor system to which at least one secondary coil comprised by the carriage is inductively coupled for the contactless transmission of electric power and/or information. It will thereby be possible to omit a supply chain, as the energy supply or the communication with the carriage is effected in a contactless way.

Document DE 10 2017 109 818 A1 describes a loading gantry in which the carriage comprises an electric energy accumulator for driving the carriage.

Therefore, it is the object of the present application to provide an improved loading gantry.

The present application comprises a loading gantry with at least one carriage traversable on a horizontal guide rail. The loading gantry according to the application comprises a media station which in at least one position of the carriage can mechanically be coupled with the same in a releasable way in order to produce at least one media connection between the media station and the carriage.

The media station thereby can take on further tasks, which in other gantries have been fulfilled by a supply chain, and/or improve the energy and/or data transmission.

The loading gantry according to the application therefore can be configured without a supply chain, i.e. without a fixed cable connection and/or hose connection between the stationary components of the loading gantry and the carriage. In particular, the carriage therefore is freely traversable along the guide rail without the constraints resulting from a supply chain.

According to the application, however, the omission of a supply chain need not be purchased through disadvantages in the supply of the carriage with media and/or in the operation of the loading gantry. In other gantries on the other hand, as far as a supply chain has been omitted, only its function with regard to the supply of the carriage with electric energy and the data transmission has been replaced, while the remaining functions of the supply chain were not taken into account. Furthermore, the energy and/or data transmission has not been solved optimally either.

The loading gantry according to the application can serve the transport of workpieces between stations of a machining system such as machining centers and/or feeding and/or discharging devices. The loading gantries can be used for the purposes which have been explained above in detail with regard to other gantries.

In a possible embodiment of the present application the media station includes at least one port which in at least one position of the carriage can be coupled with a port of the carriage in order to transmit the at least one medium to the carriage. In particular, by coupling the ports a line and/or a container of the media station can be connected to a line and/or a container of the carriage in order to transmit the medium from the media station to the carriage.

The line or lines can be a data, signal and/or power line.

However, ports of the media station serve the transmission of a physical medium. The coupling between the ports is effected in a sealing manner so that a tight connection between the port of the media station and the port of the carriage is produced.

In a first variant of the present application the ports are configured such that a connection between a particular port of the media station and a particular port of the carriage is possible in only one defined position of the carriage.

In a second variant the connection between the media station and the carriage can be effected by a port which is movably mounted on the carriage and/or the charging device and therefore allows a relative movement between carriage and charging device. As a result, a defined traversing movement of the carriage is also possible in the case of a closed connection between media station and carriage.

In a possible embodiment of the present application the coupling between the media station and the carriage is effected by an actuator of the media station and/or the carriage. In particular, the actuator can be configured such that it generates a relative movement between the ports of carriage and media station, which has at least one component that extends perpendicularly to the direction of travel of the carriage along the guide rail.

In a possible embodiment of the present application the ports on the media station and/or the carriage each comprise a valve which closes the ports when the coupling with the respective other port is released.

In a possible embodiment of the present application the media station serves to supply the carriage with at least two different media.

In a possible embodiment of the present application, the media station includes at least two ports which can be sealingly coupled with corresponding ports of the carriage, and via which at least two different media can be transmitted to the carriage.

In a possible embodiment of the present application, at least one medium as a physical medium which can be conveyed.

In a possible embodiment of the present application, at least one medium is a granular, pasty, liquid and/or gaseous medium. In particular, it can be a pasty, liquid and/or gaseous medium, in particular a fluid and/or gas.

When the media station is configured to supply the carriage with several different media, several of the different media may be physical media which can be conveyed, and/or granular, pasty, liquid and/or gaseous media. In particular, these can be a pasty, liquid and/or gaseous media, in particular several different fluids and/or gases. Alternatively or in addition, at least one of the media can be a non-physical medium such as electricity, signals and/or data, and another medium can be a physical medium.

Possible media which can be transmitted to the carriage by means of the media station, and/or applications of the media station connected therewith, will be described in detail below.

There can be used a media station with any possible combination and number of the media and/or applications described below:

In a possible embodiment of the present application, the carriage can be charged with hydraulic and/or pneumatic pressure via the media station. In particular, compressed air and/or hydraulic fluid can be transmittable to the carriage via the media station. As a result, despite the omission of a supply chain, hydraulic and/or pneumatic pressure need not be omitted for the operation of the carriage.

When hydraulic fluid is transmittable to the carriage via the media station, a backflow connection between the carriage and the media station may be also provided so that the carriage can be connected to a hydraulic circuit of the media station.

In a possible embodiment of the present application, the carriage includes a hydraulic and/or pneumatic actuator which can be operated via the hydraulic and/or pneumatic pressure supplied via the media station. For example, the actuator can be the drive of a linear axis, a joint and/or a gripper.

In a first variant, the hydraulic and/or pneumatic pressure can serve the actuation of the actuator, while the carriage is disposed in the vicinity of the media station. As certain actuators of the carriage such as a gripper usually are actuated only in defined positions of the carriage, in which the carriage itself is not moved, a hydraulic and/or pneumatic connection between media station and carriage, which is produced in such a position, is sufficient to actuate such an actuator. An actuation of the actuator in other positions of the carriage, in which a connection with the media station does not exist, then is not possible, but not necessary either.

In a second variant, the hydraulic and/or pneumatic pressure can serve for charging a hydraulic and/or pneumatic accumulator of the carriage. In positions of the carriage in which a connection with the media station does not exist, the hydraulic and/or pneumatic accumulator can then be used to actuate one or more actuators of the carriage.

In particular, a pneumatic connection between media station and carriage can be used to charge a hydraulic and/or pneumatic accumulator of the carriage.

The first and the second variant can also be used in combination.

In a possible embodiment of the present application, a lubricant system of the carriage can be charged with lubricant via the media station. This provides for an automatic lubrication of the carriage. For example, the loading gantry can include a control unit by which a supply of the carriage with lubricant is effected at regular intervals.

In a possible embodiment of the present application, the carriage can be charged with coolant via the media station. In particular, the carriage can be connectable to a coolant circuit of the media station in the at least one position in order to cool a component of the carriage. A separate cooling circuit of the carriage thereby can also be omitted.

In a possible embodiment of the present application, a data and/or signal connection between the carriage and the media station can be produced. In particular, the data and/or signal connection can be effected by producing an electrically conductive connection between ports of the carriage and the media station, in particular via a plug-and-socket system.

The data and signal connection in particular can serve the communication with a control unit and/or sensors of the carriage. In particular, the data and/or signal connection can provide for a communication between a control unit of the loading gantry and a control unit and/or sensors of the carriage.

In a possible embodiment of the present application, the carriage can be supplied with elements and/or media via the media station, which are installed and/or consumed for machining a workpiece via an actuator of the carriage.

For example, the carriage can be supplied with electronic and/or mechanical small parts, welding wire and/or solder wire and/or blasting grit for sandblasting.

In a possible embodiment of the present application, the carriage can be supplied with electric energy via the media station, wherein in at least one position of the carriage a contact element of the media station is conductively connectable with a contact element of the carriage.

As an alternative to such a conductive connection for the supply of energy, the energy supply can however also be effected in a contactless way, for example by induction. Such a contactless energy supply can also be integrated into the media station, but does not require the mechanical coupling according to the application.

In a possible embodiment of the present application, the carriage includes at least one electric drive and an electric energy accumulator for an at least partial energy supply of the drive.

In a possible embodiment of the present application, the media station comprises a charging device for charging the electric energy accumulator.

In a first variant, the electrical connection between the charging device of the media station and the carriage can be effected in a contactless way, for example by induction.

The electrical connection between the charging device of the media station and the carriage however may be effected by a conductive contact between a contact element of the media station and a contact element of the carriage, as such a connection allows considerably higher currents than a contactless connection.

In a second independent aspect the present application, independent of the previously described media station, therefore also comprises a loading gantry with at least one carriage traversable on a horizontal guide rail, for the transport of workpieces between stations of a production system, wherein the carriage includes at least one electric drive and an electric energy accumulator for an at least partial energy supply of the drive, and wherein the loading gantry comprises a charging device for charging the electric energy accumulator, wherein in at least one position of the carriage a contact element of the media station is conductively connectable with a contact element of the carriage.

An embodiment of the charging device may be configured such that charging is possible only in defined positions and/or portions along the guide rail, but not in others. The charging device can be arranged at the same positions which have already been described above as positions for the media station.

Embodiments which can be used both in a charging device of a media station according to the first aspect and also in connection with the second aspect will be described in detail below.

In a possible embodiment of the present application, the charging device allows the charging of the energy accumulator in at least two positions of the carriage.

In a possible embodiment of the present application, the charging device allows the charging of the energy accumulator in a coherent range of positions of the carriage.

In a possible embodiment of the present application, the coupling between charging device and carriage is effected by one or more power connections and/or a conductor rail.

In particular, the charging device can comprise one or more power connections to which a power connection of the carriage is coupled. Alternatively or in addition, the charging device or the carriage can comprise a conductor rail to which a current collector of the respective other part is coupled.

When a conductor rail is provided, the coupling with the current collector may be effected by traversing the carriage into the corresponding position along the guide rail.

When one or more power connections are provided at the media station, the coupling with one or more power connections of the carriage may be effected by an actuator via which the power connections are mechanically coupled with each other as soon as the carriage is in a corresponding position.

An embodiment of the loading gantry includes a control unit which activates the power supply by the charging device only after the conductive connection between the charging device and the carriage has been established. The formation of arcs during the coupling operation thereby is prevented.

In a possible embodiment of the present application, at least one media station is arranged in a working position in which the carriage stops over a station of the machining system in order to deposit or pick up a workpiece. As the carriage remains at such a working position for some time in order to deposit or pick up the workpiece, this time can now be used to supply the carriage with a medium.

Alternatively or in addition, at least one media station can be arranged in a parking position of the carriage. In the parking position, the carriage may be disposed outside the traversing path required for the transport of workpieces.

In a possible embodiment of the present application, the loading gantry comprises a plurality of media stations. In particular, one media station each can be arranged in a plurality of working positions in which the carriage stops over different stations of the machining system in order to deposit or pick up a workpiece.

The loading gantry according to the application may serve for charging the machining centers and/or feeding and/or discharging device of the production line with workpieces from above. The carriage therefor may include a component which is at least also movable in vertical direction and serves for lifting or lowering the workpieces.

In a possible embodiment of the present application, the carriage includes two grippers which each are movable in vertical direction, wherein the loading gantry includes a control unit by which in a first position of the carriage the one gripper is actuated to remove a machined workpiece from a machining station and in a second position of the carriage the other gripper is actuated to deposit a new workpiece at the machining station, wherein between the removal of the machined workpiece in the first position of the carriage and the deposition of the new workpiece in the second position of the carriage the carriage is traversed from the first to the second position along the horizontal guide rail. Traversing in particular is effected in order to sequentially arrange the one and the other gripper over the machining station.

With such a configuration of the carriage, the charging device may be configured such that charging of the energy accumulator can be effected both in the first and in the second position of the carriage. The time which is each needed for moving the grippers in the first and the second position thereby can be used for charging.

In a possible embodiment of the present application, the charging device includes a first and a second power connector, wherein in the first position a power connector of the carriage is conductively connectable with the first power connector of the charging device and in the second position with the second power connector. This may be effected by an actuator via which the power connectors are mechanically coupled with each other as soon as the carriage is disposed in a corresponding position.

In a possible embodiment of the present application, the charging device on the other hand is configured such that charging can also be effected in all intermediate positions between the first and the second position. Thus, the entire time during which the carriage is disposed above the machining station can be used.

In a first variant, this can be effected by a conductor rail.

In a second variant, the conductive connection can be effected by a power connector which is movably mounted on the carriage and/or the charging device and therefore allows a relative movement between carriage and charging device.

In a possible embodiment of the present application, the carriage at least temporarily is operable exclusively via the energy of the energy accumulator. This allows to design the charging device such that the carriage is supplied with energy only in certain traversing positions and/or traversing portions.

The carriage is operable exclusively via the energy of the energy accumulator over at least one and possibly over a plurality of traversing cycles. A traversing cycle may comprise picking up a workpiece, horizontally traversing the carriage and depositing the workpiece.

As an energy accumulator, supercaps and/or batteries may be used.

In particular, the energy supply of the carriage in normal operation can be effected via supercaps, and the batteries are used for supplying the carriage in an emergency operation.

The control unit of the carriage has an emergency operating mode in which the carriage is traversed to a charging device by means of the batteries in order to provide for charging of the supercaps. The method may be effected as a creep travel in order to save energy.

This aspect is subject-matter of the present application also independent of the aspects described above.

In a third aspect, the present application therefore comprises a loading gantry with at least one carriage traversable on a horizontal guide rail, in particular for the transport of workpieces between stations of a production system, wherein the carriage includes at least one electric drive and an electric energy accumulator for the at least partial energy supply of the drive, and the loading gantry comprises a charging device for charging the electric energy accumulator, wherein the electric energy accumulator comprises supercaps and batteries, wherein in normal operation the energy supply of the carriage is effected via the supercaps and the batteries are used for supplying the carriage in an emergency operation.

In particular, the control unit of the carriage can have an emergency operating mode in which the carriage is traversed to a charging device by means of the batteries in order to provide for charging of the supercaps.

Furthermore, the control unit of the carriage can have a normal operating mode in which the carriage is supplied with electric energy by means of the supercaps.

The system is switched into the emergency operating mode when the energy stored in the supercaps falls below a certain value.

In the emergency operating mode the carriage may be traversed at a speed which lies below the maximum speed in the normal operating mode by at least a factor of 2, or by at least a factor of 5.

The carriage includes a control unit for the at least one drive. In particular, the power electronic unit for actuating the drive can be arranged in the carriage.

The control unit of the carriage receives commands and/or synchronization data for actuating the drive from a control unit of the loading gantry. Alternatively or in addition, the control unit can send status data of the carriage to a control unit of the loading gantry.

The drive of the carriage along the guide rail is effected via a drive element of the carriage which meshes with a rack of the guide rail. The position of the carriage on the guide rail thereby is clearly determined via the position of the drive element. The drive element can be a pinion or a worm.

The carriage can include a component which is at least also movable in vertical direction. the component serves for moving the workpieces in vertical direction. The component can carry a gripper for gripping the workpieces.

In a first embodiment, the component can include a vertically movable linear axis. For example, there can be used a vertically movable rack which can be traversed vertically via a drive of the carriage. In a second embodiment, a robot arm with a plurality of swivel and/or rotation axes can be used. For example, a 6-axis industrial robot can be arranged on the carriage. Furthermore, a combination of linear axes and swivel and/or rotation axes also is conceivable.

In a first variant, the gantry according to the application can be configured as a linear gantry, in second variant as an area gantry.

The guide rail may be supported via one or more props and possibly extends above the machining centers and/or feeding and/or discharging devices of the production system. When it is a linear gantry, the props may be stationary, wherein the guide rail is firmly arranged on the props. When it is an area gantry, either the props are traversable or the guide rail on the props.

The loading gantry may be configured such that it directly grips the workpieces or that it grips pallets and/or workpiece holders which carry the workpieces.

The loading gantry according to the application can include two or more carriages which are movable along the same guide rail.

As no more energy supply chain is necessary, the loading gantry can flexibly be equipped with a plurality of carriages. This in particular provides for a flexible adaptation to changing production processes, without having to go to a major construction effort. Furthermore, the carriages can also be exchanged easily and without much effort for maintenance purposes.

The configuration of the loading gantry according to the application has the further advantage that the loading gantry can be extended easily in order to adapt the same to a changing production process or new customer requirements. For this purpose, merely the guide rail extends correspondingly, and possibly additional media stations and/or charging devices are supplemented.

The present application furthermore comprises a media station of a loading gantry as it has been described above.

Furthermore, the present application furthermore comprises a carriage of a loading gantry as it has been described above.

Media station and/or carriage may be configured such as it has already been explained above in detail.

### BRIEF DESCRIPTION OF FIGURES

The present application will now be explained in detail with reference to exemplary embodiments and drawings. In the drawings:

FIG. 1: shows a first exemplary embodiment of a loading gantry according to the application in a perspective view;

FIG. 2: shows a detail view of the first exemplary embodiment shown in FIG. 1;

FIG. 3: shows the media station arranged on the guide rail of the first exemplary embodiment shown in FIG. 1;

FIG. 4: shows the media station of the first exemplary embodiment shown in FIG. 1;

FIG. 5: shows a detail view of a second exemplary embodiment;

FIG. 6: shows the media station arranged on the guide rail of the second exemplary embodiment shown in FIG. 5;

FIG. 7: shows the media station of the second exemplary embodiment shown in FIG. 5,

FIG. 8: shows a schematic drawing of components of an exemplary embodiment of a carriage and a guide rail;

FIG. 9A: shows a first schematic drawing of components of an exemplary embodiment of a carriage and a media station; and

FIG. 9B: shows a second schematic drawing of components of an exemplary embodiment of a carriage and a guide rail;

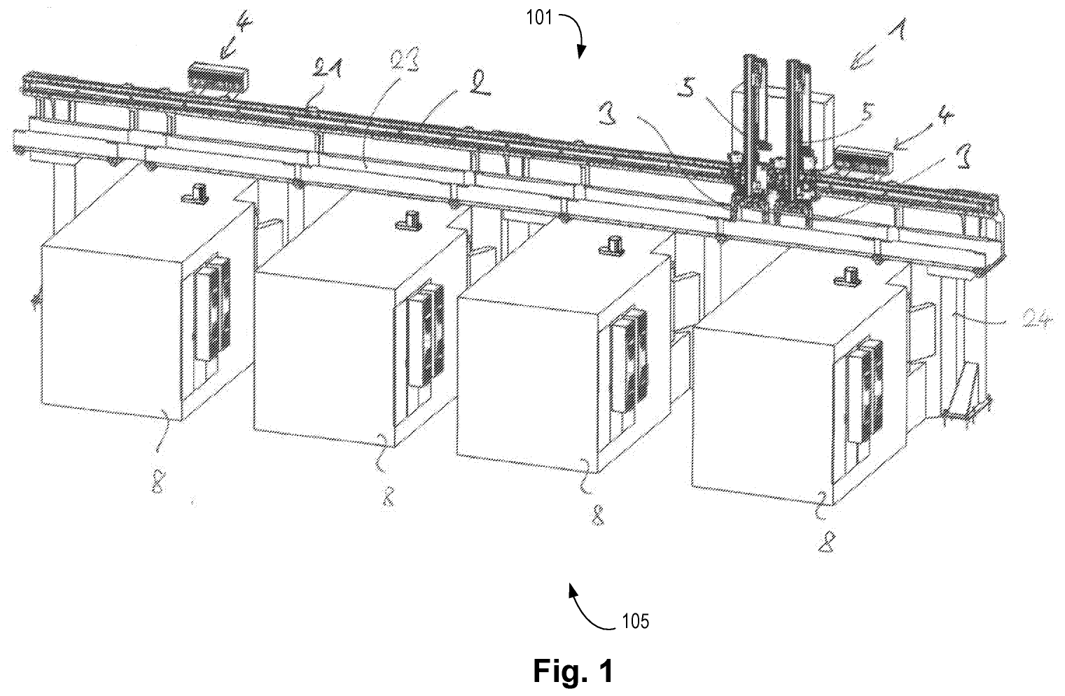

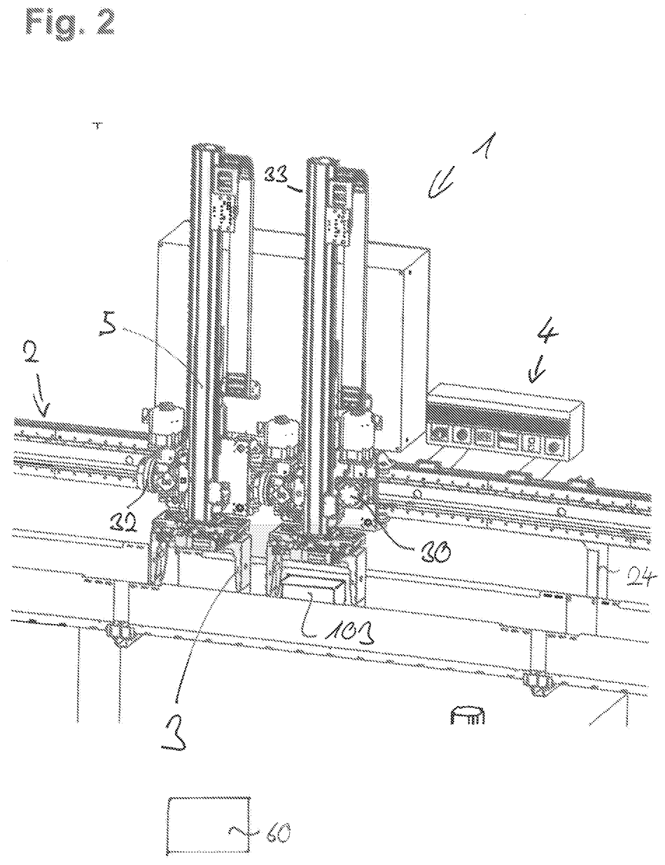

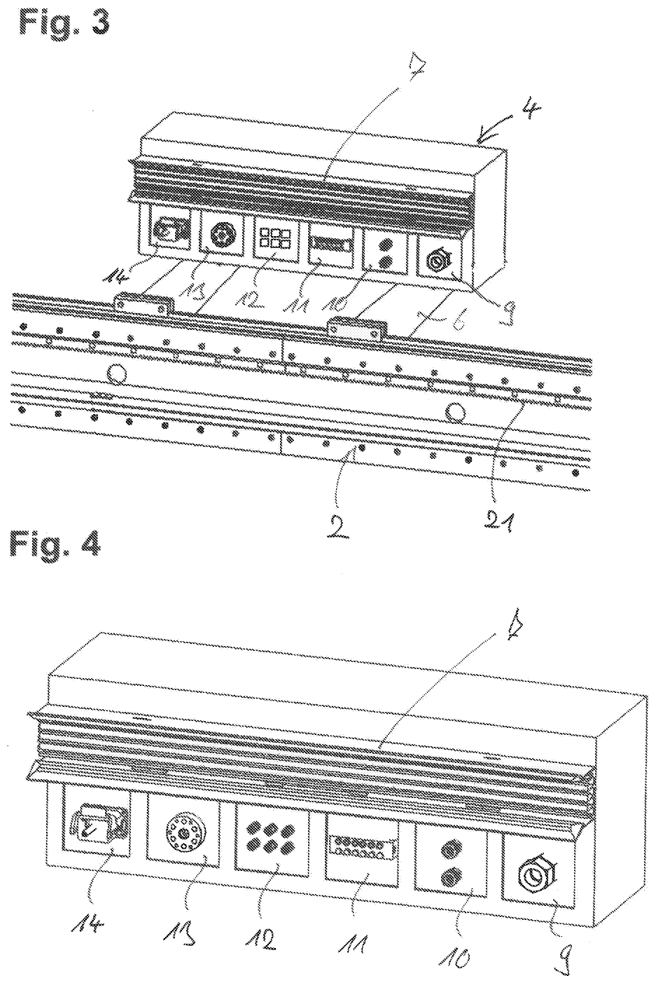

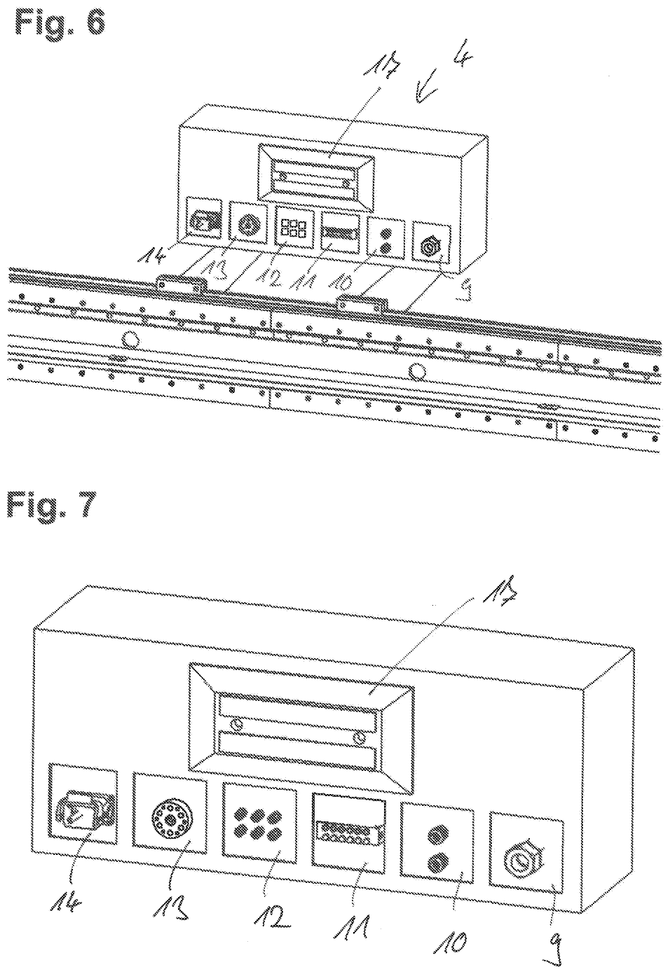

FIGS. 1-9B are shown approximately to scale.

### DETAILED DESCRIPTION

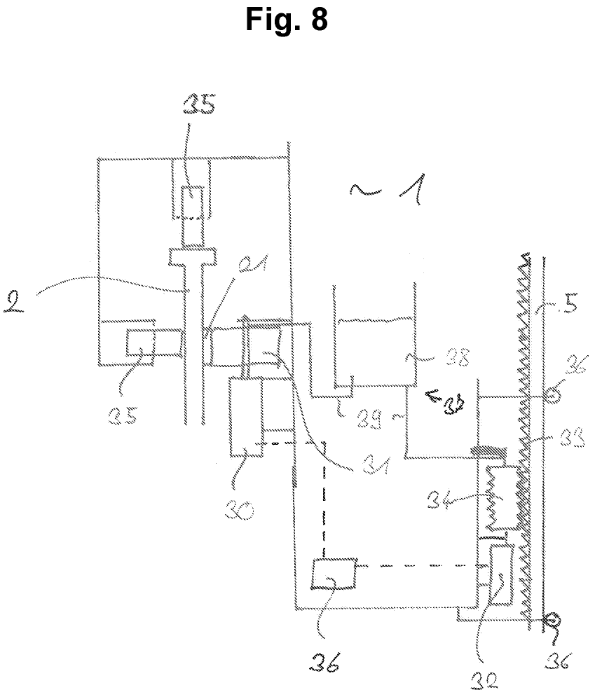

With reference to FIGS. 1 and 8, the basic construction of the exemplary embodiments of the loading gantry 101 according to the application will first be described.

In the exemplary embodiment, the loading gantry 101 includes a horizontally extending guide rail 2 on which a carriage 1 is traversable. The guide rail 2 is supported by a prop 24 and extends over a plurality of stations 8 of a machining system or production system 105.

The stations 8 of the machining system can be machine tools and/or a feeding device and/or discharging device for workpieces 103.

On the carriage 1 at least one vertically traversable component 5 is provided, which carries at least one gripper 3. Via this component, workpieces can be removed from a station of the machining system from above, be traversed to the next station by traversing the carriage 1 along the guide rail 2, and at the next station in turn be fed to the same from above. The gripper(s) 3 either can directly grip one or more workpieces or a workpiece holder such as a pallet.

The carriage 1 includes at least one drive 30 via which the carriage is traversable along the guide rail 2. In the exemplary embodiment the guide rail 2 includes a rack 21 which meshes with a drive element 31 of the carriage 1. The drive element 31 for example can be a pinion and/or a worm. The drive element 31 is driven by the at least one drive 30 of the carriage. The carriage 1 further has guide rollers 3 providing horizontal and vertical support of the carriage on the guide rail 2.

Furthermore, the carriage includes at least one drive 32 via which the vertically traversable component 5 is traversable.

The carriage 1 usually includes further drives, in particular for actuating the gripper 3 and/or for moving the gripper 3 relative to the carriage and/or the vertically traversable component 5.

In the exemplary embodiment, the vertically traversable component 5 is formed by a linear axis which includes a drive via which it can be traversed vertically. For example, there can be provided a rack 33 which meshes with a drive element 34 of the carriage and thereby is vertically traversable on the carriage. Further, guide rollers 36 for the component 25 may be provided.

In an exemplary embodiment, the carriage 1 comprises a lubricant system 37 that comprises a lubricant tank 38 and/or lubricant lines 39. The drive elements 31 and 34 may be provided with lubricant from the lubricant tank 38 and/or by the lubricant lines 39.

In the exemplary embodiment shown in FIG. 1, the carriage 1 is configured as a so-called H-configuration in which two vertical linear axes 5 with a gripper 3 are arranged on the carriage. The first gripper thereby can be used for removing a machined workpiece and the second gripper for depositing a new workpiece on a machining station.

Alternatively, a robot arm with a plurality of swivel and/or rotation axes can also be used as a vertically traversable component. For example, a six-axis industrial robot can be arranged on the carriage, for example in a suspended position or laterally at the carriage.

In the exemplary embodiment the loading gantry furthermore includes a safety and/or oil pan 22 which is arranged below the carriage 1. The safety and/or oil pan 22 extends along the traversing path of the workpieces and in the vicinity of the stations 8 of the machining system includes openings via which the workpieces can be removed from the respective station or be handed over to the respective station. The other regions of the machining system thereby are protected from workpieces falling down and/or from oil dripping down. Such a safety and/or oil pan is merely optional.

The loading gantry and/or machining system includes a control cabinet in which the control unit 60 for the loading gantry is arranged. The control unit of the loading gantry possibly allows a synchronous actuation of the loading gantry and the stations of the machining system.

The carriage 1 includes an energy accumulator 36 which serves for supplying energy to at least one drive of the carriage. The energy accumulator 36 either can serve to support an energy supply of the carriage or be designed such that the carriage at least temporarily is completely supplied with energy via the energy accumulator.

In the exemplary embodiment the drive 30, 32 is an electric drive. The energy accumulator 36 is an electric energy accumulator. In particular, a supercap and/or an accumulator can be used as an electric energy accumulator. The electric drive can be an electric motor and/or an electric linear axis.

At one or more positions along the guide rail 2 a media station 4 is provided in accordance with the application. In the exemplary embodiment the media station 4 is attached to the guide rail 2 via a holder 6. Alternatively, however, the media station might also be arranged on the ground or on a machining station 8 via a separate stand.

In at least one position of the carriage the media station according to the application releasably can be mechanically coupled with the carriage in order to produce at least one media connection between the media station and the carriage. In the exemplary embodiments shown in FIGS. 1 to 7 the media station allows the production of a plurality of media connections. Examples for such media connections to be produced via the media station will be described in detail below. The present application also comprises any other sub-combinations of the connections illustrated in the Figures.

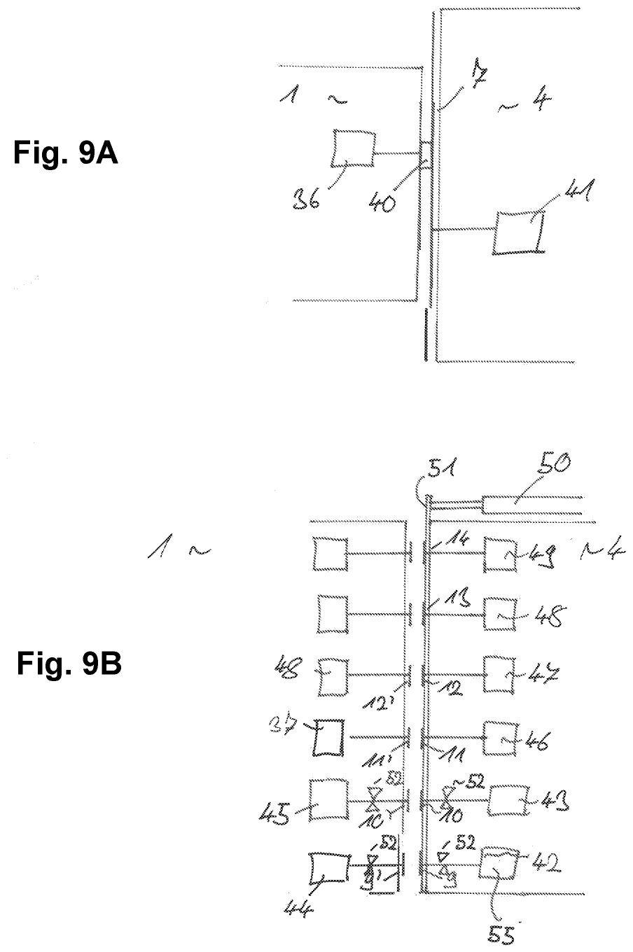

In accordance with the application, for example one or more of the following media can be transmitted, see in particular FIGS. 9A and 9B:

### Current/Electric Energy

The media station can comprise one or more contact elements which in at least one position of the carriage are conductively connectable with a contact element of the carriage in order to produce an electric energy supply of the carriage via the media station.

In the first exemplary embodiment shown in FIGS. 1 to 4 and 9A, the media station therefor includes a conductor rail 7 to which the current collector 40 of the carriage couples when the carriage is disposed in the vicinity of the media station. Coupling may be effected by the normal traversing movement of the carriage 1 along the guide rail 2 by which the collector is traversed laterally into the conductor rail. The conductor rail thereby allows the electric energy supply of the carriage over a traversing range of the carriage and in particular also during a traversing movement.

In the exemplary embodiment, the media station serves as a charging device 41 for charging the electric energy accumulator 36 of the carriage via the conductor rail 7 and the current collector 40. The use of a conductor rail 7 has the advantage that charging of the energy accumulator of the carriage is possible over an extended period.

In particular, it is possible to charge the energy accumulator without interruption also during such work processes for which a traversing movement of the carriage is necessary. In an example for such a work process a first gripper 3 is arranged in a first traversing position above a machining station 8 in order to remove a workpiece already machined there, the carriage then is traversed into a second traversing position by a certain distance in order to traverse the second gripper of the carriage into the position taken previously by the first gripper, and a new workpiece is deposited at the machining station. In this case, the media station is arranged above the machining station 8 and equipped with a conductor rail by which the electrically conductive connection between the media station and the carriage exists both in the first and in the second traversing position of the carriage.

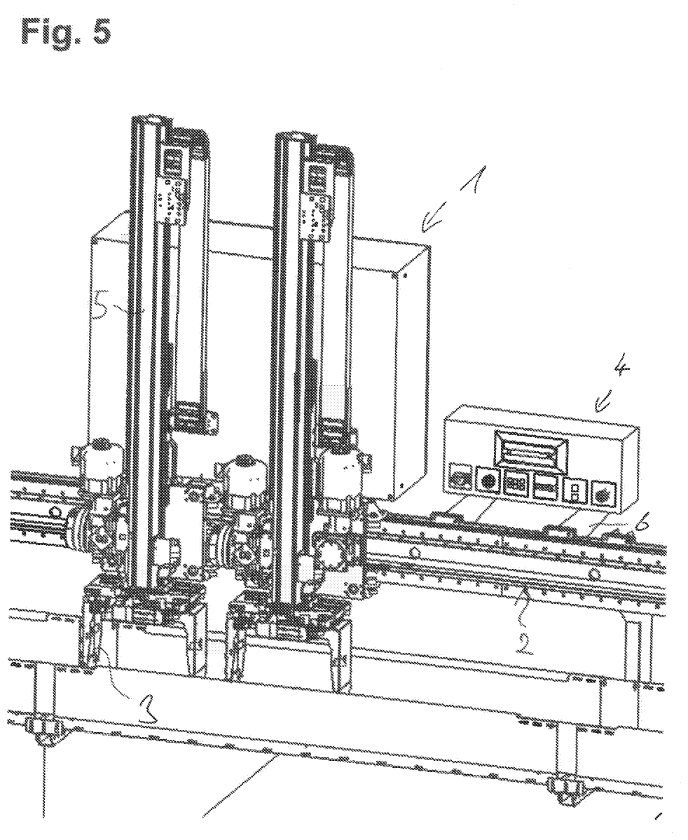

Alternatively, the power supply of the carriage can be effected via an electrical port 17 of the media station, as it is shown in FIGS. 5 to 7 for the second exemplary embodiment. The electrically conductive connection here is effected via an actuator via which the port 17 of the media station and/or a corresponding port at the carriage is moved such that the two ports are mechanically connected with each other. The port however is not configured as a sliding contact so that the connection is released again before the carriage is traversed.

By arranging a plurality of ports at the media station or by arranging one elongated port at the media station it can also be achieved in this embodiment that charging of the energy accumulator is possible in two different positions of the carriage relative to the media station, in particular in such first and second traversing positions of the carriage in which as described above a first and a second gripper of the carriage can be used to pick up a machined workpiece and to deposit a new workpiece.

In the exemplary embodiment, the media station furthermore includes electrical connecting elements for the transmission of electric energy and/or data and/or signals as possible further ports 13 and 14. The ports 13 and 14 can either be used instead of the elements described already or in addition to the same.

An embodiment of the electric energy supply via the media station is activated only after the conductive connection between the contact elements of the carriage and the media station is produced. In particular, the rail 7 or the contact elements 17 can be set under current only when the same are conductively connected with the corresponding contact elements of the carriage. Thereby, a formation of sparks is avoided.

Hydraulic and/or Pneumatic Media

In the exemplary embodiment, the media station includes a pneumatic port 9 via which a compressed air supply of the carriage can be effected. The carriage 1 comprises a corresponding port 9′ releasably coupling with port 9 of the media station. Actuators 44 of the carriage thereby can be charged with pneumatic pressure from a pneumatic pressure source 42 while the connection exists.

The media station furthermore includes a hydraulic port 10 via which the carriage is connectable to a hydraulic circuit 42 and in particular to a pump of the media station. The carriage 1 comprises a corresponding port 10′ releasably coupling with port 10 of the media station. Actuators 45 of the carriage thereby can be charged with hydraulic pressure while the connection exists. Furthermore, the hydraulic connection also constitutes a backflow connection for the hydraulic fluid.

The pneumatic and/or hydraulic connection can be used either for the direct operation of a pneumatic and/or hydraulic actuator 44, 45, while the connection is produced, and/or for charging an accumulator whose energy can also be used while the connection is released again. The pneumatic and/or hydraulic actuator 44, 45 for example can actuate the gripper.

Valves 52 may be provided on the ports 9, 10 and 9′, 10′ to close the ports if they are not coupled to each other.

### Lubricant

In the exemplary embodiments, the media station includes a port 11 via which a lubrication of the carriage, in particular of a drive 30, 32 and/or an axis of movement of the carriage, can be effected. The carriage 1 comprises a corresponding port 11′ releasably coupling with port 11 of the media station.

In the exemplary embodiment, the port 11 comprises a plurality of lubricant channels which are connected with corresponding lubricant channels of the carriage in order to separately supply different lubricating points or lubricating lines 39 with lubricant from a lubricant source 46 comprising lubricant 55 as a medium to be transferred from the media station to the carriage.

Alternatively or in addition, the media station might also be used for filling a central lubricant container 38 of the carriage.

### Coolant

The media station furthermore can include a port for connecting a cooling system of the carriage with a cooling circuit of the media station. This allows a cooling of elements of the carriage while the same is coupled with the media station. the coolant circuit of the media station includes at least one heat exchanger and/or condenser. The coolant system of the carriage thereby can be of simpler design.

### Data/Signals

In the exemplary embodiments, the media station furthermore includes a port 12 for the transmission of signals and/or data between the media station and the carriage. For establishing the data and/or signal connection contact elements of the media station are conductively connected with contact elements 12′ of the carriage. The contact elements can be configured in the form of a plug/socket system. The data and/or signal connection may be used to transmit data and/or control commands between a communication line 47 of the media station and a communication line 48 of the carriage 1.

Thereby, data for example can be read out from the carriage and/or control commands can be transmitted to the carriage. Due to the conductive connection considerably higher bandwidths and a safer transmission than in wireless systems are possible.

### Consumables

The media station furthermore can serve the supply of the carriage with consumables 48, 49 which during the operation of the carriage are needed for machining a workpiece. In particular, small parts, welding wire and/or blasting grit for the machining of workpieces can be transferred to the carriage by means of the media station. These consumables may be supplied by ports such as ports 13 and 14.

### Mechanical Connection

For the mechanical connection of the port or ports of the media station with the corresponding ports of the carriage an actuator 50 is present in exemplary embodiments except for the conductor rail, which generates a relative movement between the port or ports of the media station and the ports of the carriage, wherein the relative movement at least also comprises a component in a direction perpendicular to the traversing movement of the carriage along the guide rail 2. By this actuator the port or ports can be moved towards each other and be mechanically coupled with each other. the actuator also serves for releasing the coupling.

A joint coupling arrangement can be used for the joint movement of a plurality of different ports into a coupling position.

In particular, a plurality of different ports can be arranged on a coupling element 51 which by means of the actuator is movable into a coupling position and/or is moved out of the coupling position into an uncoupled position.

Alternatively, individual ports also can each include separate coupling arrangements and/or actuators.

The ports of the media station are moved towards the ports of the carriage via one or more coupling arrangements, when said carriage is disposed in the suitable position opposite the media station.

In a possible embodiment of the present application, at least one of the media connections between media station and carriage can be produced only in a single defined traversing position of the carriage. In the exemplary embodiments shown in FIGS. 1 to 7, media connections can be produced only in one traversing position of the carriage, possibly except for the connection for the electric energy supply. Other embodiments include forming connections at multiple positions.

In a possible embodiment of the present application, ports of the media station and/or of the carriage might be arranged on the media station and/or on the carriage so as to be traversable by a certain distance in the direction of travel of the carriage. After the production of the mechanical connection, this allows a certain relative movement of the carriage to the media station without having to release the media connection.

The actuation of the loading gantry may be effected fully automated. The coupling between the ports of the media station and the carriage may be effected automatically by a corresponding actuation of the actuator used therefor, when the carriage is in a suitable traversing position. In the same way, releasing of the coupling may be effected automatically by a corresponding actuation of the actuator used therefor, before the carriage is traversed into another traversing position in which coupling is not possible.

Instead of the electric energy supply via the production of a conductive connection according to the application the energy supply might also be effected wirelessly. For example, in the vicinity of the media station an induction coil might be provided for this purpose, via which a wireless energy supply of the carriage can be effected when the same is disposed in the vicinity of the media station. In this embodiment of the media station only serves the transfer of at least one further medium, which has been described above.

The energy supply can be used for charging the energy accumulator and/or for the energy supply of one or more drives of the carriage.

Independent of whether the energy supply is effected via an electrically conductive contact or wirelessly, the same may be configured such that charging of the energy accumulator of the carriage is effected with a current of more than 100 Ampere.

The media station may be arranged in areas of the guide rail 2 in which the carriage anyway stops during the normal operation. In particular, it can be arranged over a machine tool, a raw part removal unit and/or a finished part deposition unit.

Furthermore, a plurality of media stations can also be arranged along the guide rail 2, as this is shown in FIG. 1. the media stations are arranged at the above-mentioned positions also in this case.

A media station in a parking position, which lies outside the traversing path necessary for the normal operation, likewise is conceivable.

The use of the media station has the advantage that the previously necessary supply chain for supplying the carriage 1 can be omitted. A considerably higher flexibility thereby is achieved in the design and in particular in the expansion of the loading gantry. Furthermore, the supply chain is a wear part which can now be omitted.

Furthermore, the solution according to the application in principle allows the use of an arbitrary number of carriages on a loading gantry, i.e. on a guide rail, as it is no longer necessary to provide a corresponding number of supply chains. Moreover, individual carriages can easily be removed and exchanged for example for maintenance purposes. For this purpose, it is merely necessary to release or again produce the mechanical connection with the guide rail 2.

In another independent aspect of the present application the electric energy accumulator of the carriage 1 comprises both supercaps and batteries. In normal operation, the operation of the carriage is effected via the energy provided by the supercaps, as the supercaps provide for very fast charging. The batteries on the other hand serve for supplying energy in an emergency operation, in particular after a failure of the power supply of the loading gantry or an emergency stop at a position at which no media station and/or charging station is arranged.

As the supercaps have a very high rate of self-discharge, the same possibly already are discharged so much after a standstill of the system that the carriage can no longer be traversed via the supercaps. In this case, the batteries provide for a creep travel to the next media station in an emergency operating mode in order to be able to again charge the supercaps.

This aspect of the configuration of the carriage according to the application also is subject-matter of the present application independent of the use of a media station according to the application.

In the exemplary embodiment, the loading gantry is configured as a linear gantry so that the guide rail 2 is stationarily arranged on the ground via the prop 24.

In the same way, the present application can also be used on an area gantry in which the guide rail 2 can be horizontally traversed perpendicularly to its extension. This can either be effected via a traversable prop 10 or by the guide rail 2 being traversably arranged on the prop 24.

FIGS. 1-9B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. For example, the above technology can be applied to linear or area gantries. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure

1. A loading gantry with at least one carriage traversable on a horizontal guide rail, the loading gantry including a media station which in at least one position of the carriage is releasably mechanically coupled to the carriage in order to produce at least one media connection between the media station and the carriage.

2. The loading gantry according to claim 1, wherein the media station includes at least one port which in at least one position of the carriage can be coupled with a port of the carriage in order to transmit the at least one medium to the carriage.

3. The loading gantry according to claim 1, wherein at least one medium is a granular, pasty, liquid and/or gaseous medium.

4. The loading gantry according to claim 1, wherein the carriage can be charged with hydraulic and/or pneumatic pressure via the media station.

5. The loading gantry according to claim 1, wherein a lubricant system of the carriage can be charged with lubricant via the media station.

6. The loading gantry according to claim 1, wherein the carriage can be charged with coolant via the media station.

7. The loading gantry according to claim 1, wherein a data and/or signal connection can be produced between the carriage and the media station.

8. The loading gantry according to claim 1, wherein via the media station the carriage can be supplied with elements and/or media which via an actuator of the carriage are installed and/or consumed for machining a workpiece, the elements and/or media comprise one or more of: electronic and/or mechanical small parts, welding wire and/or solder wire and/or blasting grit for sand blasting.

9. The loading gantry according to claim 1, wherein the carriage can be supplied with electric energy via the media station, wherein in at least one position of the carriage a contact element of the media station is conductively connectable with a contact element of the carriage.

10. The loading gantry according to claim 1, wherein at least one media station is arranged in a working position, in which the carriage stops over a station of the machining system in order to deposit or pick up a workpiece, and/or in a parking position of the carriage.

11. The loading gantry according to claim 1, wherein the carriage includes two grippers which each are movable in vertical direction, wherein the loading gantry includes a control unit by which in a first position of the carriage the one gripper is actuated to remove a machined workpiece from a machining station and in a second position of the carriage the other gripper is actuated to deposit a new workpiece at the machining station, wherein between the removal of the machined workpiece in the first position of the carriage and the deposition of the new workpiece in the second position of the carriage the carriage is traversed from the first to the second position along the horizontal guide rail in order to sequentially arrange the one and the other gripper over the machining station.

12. The loading gantry according to claim 9, wherein the charging device is configured such that charging of the energy accumulator can be effected both in the first and in the second position of the carriage, and/or charging can be effected in all intermediate positions between the first and the second position.

13. The loading gantry according to claim 1, wherein the drive of the carriage along the guide rail is effected via a drive element of the carriage which meshes with a rack of the guide rail, and/or wherein the carriage includes a component which is at least also movable in vertical direction, wherein the component serves for moving the workpieces in vertical direction and/or carries a gripper, wherein the component includes a vertically movable linear axis and/or a robot arm with a plurality of swivel and/or rotation axes.

14. The loading gantry according to claim 1, wherein the loading gantry is a linear gantry or an area gantry and/or wherein the guide rail is supported via one or more props.

15. A media station and/or carriage of a loading gantry,
the carriage traversable on a horizontal guide rail, for the transport of workpieces between stations of a production system,
the media station releasably mechanically coupled to the carriage in at least one position of the carriage forming at least one media connection between the media station and the carriage.

16. The loading gantry according to claim 2, wherein coupling is effected by an actuator of the media station and/or the carriage and/or the ports each include a valve which closes the ports when the coupling with the respective other port is released.

17. The loading gantry of claim 4, wherein the carriage includes a hydraulic and/or pneumatic actuator which is operable via the hydraulic and/or pneumatic pressure supplied via the media station, wherein the hydraulic and/or pneumatic pressure serves for actuating the actuator while the carriage is disposed in the vicinity of the media station, and/or wherein the hydraulic and/or pneumatic pressure serves for charging a hydraulic and/or pneumatic accumulator of the carriage.

18. The loading gantry of claim 6, wherein the carriage in the at least one position can be connected to a coolant circuit of the media station in order to cool a component of the carriage.

19. The loading gantry of claim 7, wherein the data and/or signal connection is established by producing an electrically conductive connection between ports of the carriage and the media station.

20. The loading gantry of claim 9, wherein the carriage includes at least one electric drive and an electric energy accumulator for at least partly supplying the drive with energy, and the loading gantry comprises a charging device for charging the electric energy accumulator, and/or wherein the loading gantry includes a control unit which activates the power supply by the charging device only after the conductive connection between the charging device and the carriage has been produced.

21. A production system comprising a plurality of stations and a loading gantry according to claim 1 for the transport of workpieces between the plurality of stations.
